(19) United States
(12) Patent Application Publication
(10) Pub. No.: US 2011/0058537 A1
(43) Pub. Date: Mar. 10, 2011

(54) MOBILE ELECTRONIC DEVICE AND COMMUNICATION METHOD APPLICABLE THERETO

(75) Inventor: Yueh-Ching HSU, Taipei (TW)

(73) Assignee: Inventec Appliances Corp., Taipei (TW)

(21) Appl. No.: 12/879,737

(22) Filed: Sep. 10, 2010

(30) Foreign Application Priority Data
Sep. 10, 2009 (TW) 98130585

(51) Int. Cl. H04W 4/00

(52) U.S. Cl. 370/338

(57) ABSTRACT

A mobile electronic device and a communication method applicable thereto. The mobile electronic device includes a microprocessor, a routing IC and a modem unit. The microprocessor is used to connect with at least one first external device via the routing IC. The modem unit is coupled to the microprocessor for connecting with a base station, so that the first external device is enabled to communicate with the base station via the mobile electronic device.

This application claims the benefit of Taiwan application Serial No. 98130585, filed Sep. 10, 2009, the subject matter of which is incorporated herein by reference.

### BACKGROUND OF THE INVENTION

1. Field of the Invention

The invention relates in general to a mobile electronic device and a communication method applicable thereto, and more particularly to a mobile electronic device with broadband sharing function and a communication method applicable thereto.

2. Description of the Related Art

The mobile communication industry is booming globally, and convenient mobile communication network become available to the consumers via the mobile electronic devices. Furthermore, if the mobile broadband Internet access provided by the telecommunications industry is available, the consumers can have Internet access anywhere and anytime via the mobile electronic devices. Also, computers can be connected to the Internet via the mobile electronic devices. Examples of the mobile electronic device include mobile phones, personal digital assistance (PDA) and so on.

Conventional mobile electronic devices can only enable one computer to be connected to the Internet at one time, and cannot enable multiple computers to be connected to the Internet at the same time. Therefore, it is still not popular for the households or the workplaces, which normally have more than one computer, to replace the existing cable broadband Internet access with the mobile broadband Internet access provided through a mobile electronic device. In consequence, the consumers cannot use more convenient Internet access at low cost.

Therefore, how to provide Internet access to multiple computers/users by a single mobile electronic device so as to share Internet access cost and increase the convenience in anywhere and anytime Internet access has become a prominent task for the industries.

### SUMMARY OF THE INVENTION

Examples of the invention are a mobile electronic device and a communication method applicable thereto. A routing IC of the mobile electronic device is used to enable one or more first external device to be connected to the Internet through the mobile electronic device. It's noted that the word “routing” herein is the present participle of the verb “route” which may ordinarily mean to send by a selected route or to divert in a specified direction. Thus, first external devices may be connected to the Internet at the same time, hence providing the convenience of allowing multiple users of the first external devices to access Internet at the same time, and providing e.g. a benefit of reducing the fees for Internet access paid by each of the multiple users, as only one mobile electronic device is needed to achieve the multiple-user Internet access. In addition, the mobile electronic device may also connect with a second external device via an I/O interface to allow the second external device to be connected to the Internet as well. Examples of the first and the second external device include a computer, a PDA and a mobile phone.

A first example of the present invention is a mobile electronic device including: a routing integrated circuit (IC); a microprocessor for connecting with at least one first external device via the routing IC; and a modem unit coupled to the microprocessor for connecting with a base station, in order to enable the first external device to communicate with the base station via the mobile electronic device.

A second example of the present invention is a communication method applicable to a mobile electronic device. The communication method includes the following steps. The mobile electronic device is connected with at least one first external device via a routing integrated circuit (IC). The mobile electronic device is connected with a base station. The first external device communicates with the base station via the mobile electronic device.

It is to be understood that both the foregoing general description and the following detailed description are exemplary and explanatory only and are not restrictive of the disclosed embodiments, as claimed.

### BRIEF DESCRIPTION OF THE DRAWINGS

FIG. 1 shows a block diagram of a mobile electronic device according to an embodiment of the invention;

FIG. 2 shows a flowchart of a communication method applicable to the mobile electronic device of FIG. 1 according to the embodiment of the invention; and

FIG. 3 shows a detailed flowchart of the communication method applicable to the mobile electronic device of FIG. 1 according to the embodiment of the invention.

### DETAILED DESCRIPTION OF EXEMPLARY EMBODIMENT OF THE INVENTION

A mobile electronic device or a hand-held electronic device, such as a mobile phone, a PDA, or a smart phone, is disclosed as an embodiment of the invention. The mobile electronic device or the hand-held electronic device is hereinafter collectively called the mobile electronic device. The mobile electronic device includes a microprocessor and a modem unit (a modulator-demodulator device). The user could achieve mobile broadband Internet access with the mobile electronic device, so as to provide Internet access function to a first external device connecting to the mobile electronic device via a routing IC, or to provide Internet access function to a second external device connecting to the I/O interface of the mobile electronic device. It's noted that the word “routing” herein is the present participle of the verb “route” which may ordinarily mean to send by a selected route or to divert in a specified direction.

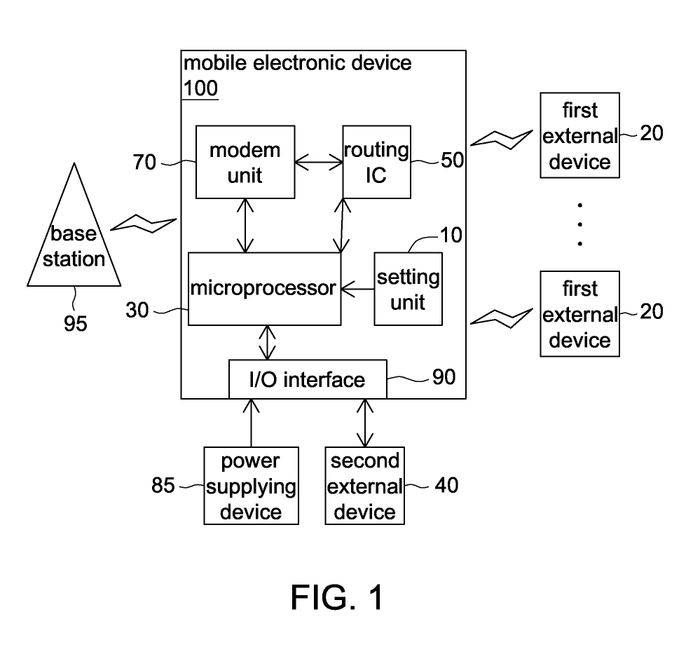

Referring to FIG. 1, a block diagram of a mobile electronic device according to an embodiment of the invention is shown. The mobile electronic device 100 includes a setting unit 10, a microprocessor 30, a routing IC 50, a modem unit 70 and an I/O interface 90. The I/O interface 90 is, for example, a universal serial bus (USB) interface. The setting unit 10 is used to set the microprocessor 30 connecting with at least one first external device 20 via the routing IC 50, that is, the mobile electronic device 100 could transmit data with at least one first external device via the routing IC 50. Or, the setting unit 10 is used to set the microprocessor 30 connecting with the second external device 40 via the I/O interface 90. That is, the mobile electronic device 100 could transmit data with the second external device 40 via the I/O interface 90.

Based on the setting by the setting unit 10, the microprocessor 30 is used for connecting with the first external device 20 via the routing IC 50 or connecting with the second external device 40 via the I/O interface 90. The first external device 20 is used for communicating with the base station 95 via the mobile electronic device 100, or, the second external device 40 is used for communicating with the base station 95 via the mobile electronic device 100.

In an embodiment, the mobile electronic device 100 is used for connecting with at least one first external device 20 by for example the Bluetooth technology or the infrared data association (IrDA) technology.

The routing IC 50 and the first external device 20 may both support a wireless local area network standard. For example, the routing IC 50 is used for transmitting signals wirelessly with the first external device 20 via one of the set of IEEE 802.11 standards. Examples of the first external device 20 include a computer, a PDA and a mobile phone.

In an embodiment, the modem unit 70 is used to connect with the base station 95 for enabling the first external device 20 to communicate with the base station 95 via the mobile electronic device 100. The modem unit 70 may support the point-to-point protocol (PPP); and the base station 95 may support, for example, the 3rd generation (3G) communication technology or the 3.5G mobile communication technology.

As indicated in FIG. 1, the mobile electronic device 100 may further include a power supplying device 85. When the routing IC 50 is used to connect with multiple first external devices 20, the power consumed by the mobile electronic device 100 would increase accordingly. Meanwhile, the I/O interface 90 can be used to electrically connect to the power supplying device 85, which provides the mobile electronic device 100 with power needed to ensure proper operation of the mobile electronic device 100 under higher power consumption.

As indicated in FIG. 1, in an embodiment, when the modem unit 70 receives a data package, the routing IC 50 receives the data package via the microprocessor 30 and further transmits the data package to the first external device 20. In another embodiment, when the modem unit 70 receives the data package, the routing IC 50 could directly receive the data package from the modem unit 70 and further transmit the data package to the first external device 20. For better encryption during transmission, the data package could pass through the microprocessor 30. Compared with the case that the data package does not pass through the microprocessor 30, the case that the data package pass through the microprocessor 30 may have superior encryption because the microprocessor 30 may encrypt the data packet. Besides encryption by the routing IC 50 or by the microprocessor 30, the authority of the first external device 20 could be limited by the microprocessor 30, for better security during the transmission of the data package to the first external device 20.

When multiple users would like to be individually connected to the Internet via the respective first external devices 20, they can make use of the mobile broadband Internet access function of the mobile electronic device 100 to allow their first external devices 20 to communicate with the base station 95 thereby connecting to the Internet at the same time. Thus, the users can not only share in paying the fees for the Internet access as only one mobile electronic device is required, but also can have the convenience of mobile accessing the Internet at anytime.

As indicated in FIG. 1, the microprocessor 30 is used to connect with the second external device 40 via the I/O interface 90. When the second external device 40 communicates with the base station 95 via the mobile electronic device 100, the modem unit 70 receives the data package and the microprocessor 30 can transmit the data package to the second external device 40 via the I/O interface 90. That is, the modem unit 70 is used to enable the second external device 40 to communicate with the base station 95 via the mobile electronic device 100. The second external device 40 may support USB capability. Examples of the second external device 40 include a computer, a mobile phone and a PDA.

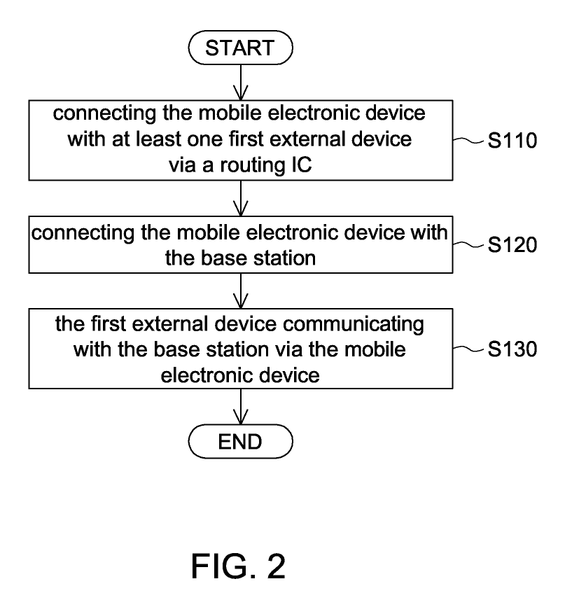

Referring to both FIG. 1 and FIG. 2. FIG. 2 shows a flowchart of the communication method applicable to the mobile electronic device of FIG. 1 according to an embodiment of the invention. In step S110, the mobile electronic device 100 connects with at least one first external device 20 via the routing IC 50.

In step S120, the mobile electronic device 100 is connected with the base station 95 by for example the modem unit 70. In step S130, the first external device 20 is used to communicate with the base station 95 via the mobile electronic device 100 by for example the modem unit 70. A detailed flowchart is further disclosed below.

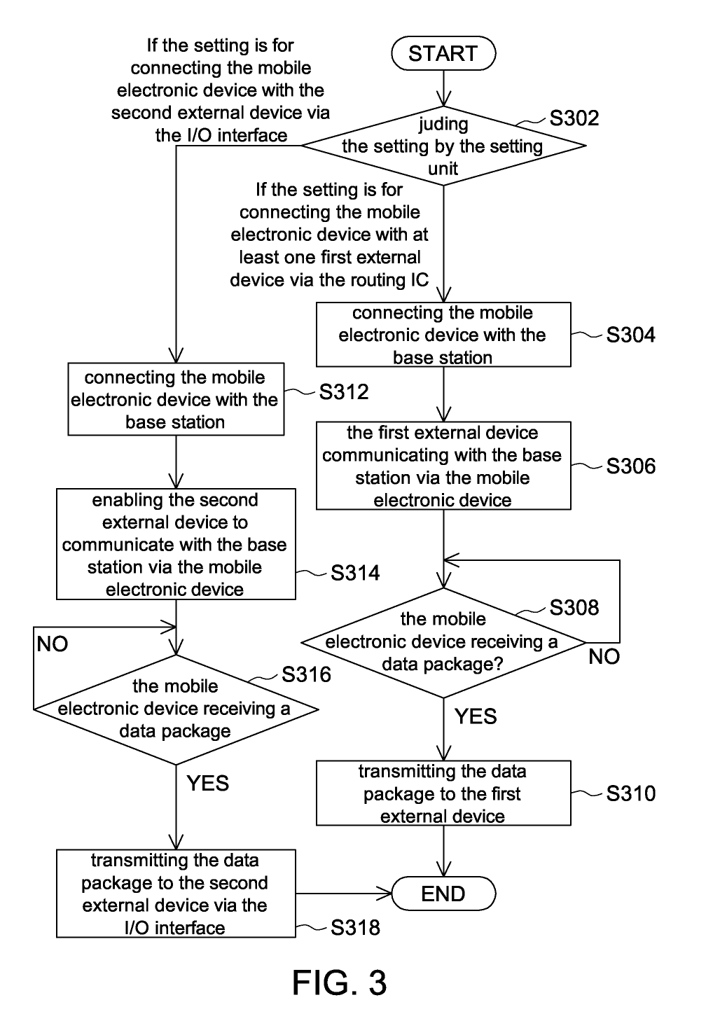

Referring to FIG. 3, a detailed flowchart of the communication method applicable to the mobile electronic device of FIG. 1 according to the embodiment of the invention is shown. In step S302, the setting by the setting unit 10 is judged; and the setting is that the mobile electronic device 100 is set to connect with at least one first external device 20 via the routing IC 50, or the mobile electronic device 100 is set to connect with the second external device 40 via the I/O interface 90. If the setting is for connecting the mobile electronic device 100 with at least one first external device 20 via the routing IC 50, then step S304 is performed. If the setting is for connecting the mobile electronic device 100 with the second external device 40 via the I/O interface 90, then step S312 is performed.

In step S304, the mobile electronic device 100 is connected with the base station 95 by for example the modem unit 70.

In step S306, the first external device 20 is used to communicate with the base station 95 via the mobile electronic device 100 by for example the modem unit 70.

In step S308, the microprocessor 30 determines whether the mobile electronic device 100 receives a data package. If yes, then step S310 is performed. If no, then the current step S308 is repeated.

In step S310, the mobile electronic device 100 transmits the data package to the first external device 20. The data package is received by for example the modem unit 70 of the mobile electronic device 100. The mobile electronic device 100 is used to communicate with the first external device by for example the Bluetooth technology or the infrared data association (IrDA) technology. The data package is transmitted to the first external device 20 by for example the routing IC 50 of the mobile electronic device 100.

In an example, the data package could be transmitted to the first external device 20 via for example the microprocessor 30 and the routing IC 50, so as to enhance the encryption of the data package. In another example, the data package could be transmitted to the first external device 20 via the routing IC 50 but not pass through the microprocessor 30.

In step S312, the mobile electronic device 100 is connected with the base station 95 by for example the modem unit 70.

In step S314, the second external device 20 is used to communicate with the base station 95 via the mobile electronic device 100 by for example the modem unit 70.

In step S316, the microprocessor 30 determines whether the mobile electronic device 100 receives a data package. If yes, then step S318 is performed. If no, then the current step S316 is repeated.

In step S318, the mobile electronic device 100 transmits the data package to the second external device 40 via for example the I/O interface 90. The data package is received by for example the modem unit 70 of the mobile electronic device 100.

The mobile electronic device and the communication method applicable thereto disclosed as the above or other possible embodiments of invention enable one or more first external devices to be connected to the Internet through the mobile electronic device at the same time. The mobile electronic device is connected to the Internet first; and the routing IC enables multiple users (i.e. multiple first external devices) to be individually connected to the Internet, wherein the routing IC and the multiple first external devices may support the Bluetooth technology or the infrared data association (IrDA) technology. Thus, the mobile electronic device and the communication method applicable thereto disclosed as the above or other possible embodiments of invention not only provide e.g. a benefit of reducing the fees for Internet access that are to be paid by each of the multiple users as only one mobile electronic device is needed to achieve the multiple-user Internet access but also provide the convenience of allowing multiple users of the first external devices to access Internet at the same time. Example of the present invention has the potential for replacing conventional cabled broadband and is very competitive in the market.

It will be appreciated by those skilled in the art that changes could be made to the disclosed embodiments described above without departing from the broad inventive concept thereof. It is understood, therefore, that the disclosed embodiments are not limited to the particular examples disclosed, but is intended to cover modifications within the spirit and scope of the disclosed embodiments as defined by the claims that follow.

What is claimed is:

1. A mobile electronic device, comprising:
a routing integrated circuit (IC);
a microprocessor for connecting with at least one first external device via the routing IC; and
a modem unit coupled to the microprocessor for connecting with a base station, in order to enable the first external device to communicate with the base station via the mobile electronic device.

2. The mobile electronic device according to claim 1, wherein the routing IC further communicates with the first external device by Bluetooth technology or infrared data association (IrDA) technology.

3. The mobile electronic device according to claim 1, wherein, if the modem unit receives a data package, the routing IC receives the data package via the microprocessor and transmits the data package to the first external device.

4. The mobile electronic device according to claim 1, wherein, if the modem unit receives a data package, the routing IC receives the data package from the modem unit and transmits the data package to the first external device.

5. The mobile electronic device according to claim 1, further comprising an input/output (I/O) interface, wherein the microprocessor is further used to connect to a second external device via the I/O interface, and the modem unit is further used to enable the second external device to communicate with the base station via the mobile electronic device.

6. The mobile electronic device according to claim 5, wherein the I/O interface is a universal serial bus (USB) interface.

7. The mobile electronic device according to claim 5, wherein if the modem unit receives a data package, the microprocessor receives the data package from the modem unit and then transmits the data package to the second external device via the I/O interface.

8. The mobile electronic device according to claim 5, further comprising a power supplying device electrically connected to the I/O interface for providing the mobile electronic device with power.

9. The mobile electronic device according to claim 5, further comprising a setting unit for setting the microprocessor to connect with the first external device via the routing IC or setting the microprocessor to connect with the second external device via the I/O interface.

10. The mobile electronic device according to claim 1, wherein the modem unit supports point-to-point protocol (PPP).

11. The mobile electronic device according to claim 1, wherein the routing IC supports a wireless local area network standard of IEEE 802.11.

12. A communication method applicable to a mobile electronic device, comprising:
connecting the mobile electronic device with at least one first external device via a routing integrated circuit (IC);
connecting the mobile electronic device with a base station; and
the first external device communicating with the base station via the mobile electronic device.

13. The communication method according to claim 12, wherein the step of the first external device communicating with the base station via the mobile electronic device comprises the mobile electronic device communicating with the first external device by Bluetooth technology or infrared data association (IrDA) technology.

14. The communication method according to claim 12, wherein the mobile electronic device further comprises an input/output (I/O) interface, and the communication method further comprises:
connecting the mobile electronic device with a second external device via the I/O interface.

15. The communication method according to claim 14, further comprising:
when the mobile electronic device receives a data package, the mobile electronic device transmitting the data package to the second external device via the I/O interface.

16. The communication method according to claim 14, further comprising:
providing the mobile electronic device with power via the I/O interface.

17. The communication method according to claim 14, further comprising:
setting the mobile electronic device to connect with the first external device via the routing IC or setting the mobile electronic device to connect with the second external device via the I/O interface.

18. The communication method according to claim 14, wherein, the I/O interface is a universal serial bus (USB) interface.

19. The communication method according to claim 12, wherein, the first external device supports point-to-point protocol (PPP).

20. The communication method according to claim 12, wherein, the routing IC supports a wireless local area network standard of IEEE 802.11.
